(19) United States
(12) Patent Application Publication
(10) Pub. No.: US 2005/0179647 A1
(43) Pub. Date: Aug. 18, 2005

(54) Automatic detection and switching between input modes

(75) Inventors: Alex Simmons, Redmond, WA (US); Christopher Pratley, Seattle, WA (US); Kentaro Urata, Kirkland, WA (US)

Correspondence Address: Christopher J. Leonard;Merchant & Gould P.C., P.O. Box 2903, Minneapolis, MN, 55402-0903, US

(73) Assignee: Microsoft Corporation

(21) Appl. No.: 10/781,489

(22) Filed: Feb. 18, 2004

(51) Int. Cl. G09G 5/00

(52) U.S. Cl. 345/156

(57) ABSTRACT

Automatic detection and switching between computer-enabled input modes is provided. An automatic switching input mode may be selected that allows input modes to be automatically switched from one mode to another based on user behavior. If a user's computer system is in selection mode (keyboard or mousing device), the user may enter and manipulate data via mouse movement or keyboard selection. If the user moves an electronic pen to the user's computer display screen, her computer system automatically switches to pen input mode without the requirement that the user manually switch to pen mode. Subsequently, if the user moves her mousing device or selects a key on her keyboard, her system automatically switches back to selection mode. Additionally, one input mode may be readily latched for operation as a different input mode. For example, a user may latch a pen input mode for operation as a mouse input mode. Conversely, a mouse input mode may be latched for operation as a pen input mode. Each input mode may be easily switched back to its natural state based on user behavior.

### FIELD OF THE INVENTION

The present invention generally relates to methods and systems for inputting and manipulating data in a computing environment. More particularly, the present invention relates to automatic switching between input modes.

### BACKGROUND OF THE INVENTION

Since the advent of the computer age, hardware and software systems have been developed for allowing users to efficiently enter and manipulate text and data that is displayed on a computer-generated display. In the early days of computing, users were primarily restricted to manipulating display text and data through a variety of keyboard strokes. The advent of mousing devices, including keyboard touchpads, gave users enhanced access to display data by allowing users to freely move a mouse pointer or curser about displayed information for selecting data for manipulation or input. Recently, a variety of pen and ink systems have been developed that allow users to select and manipulate displayed text and data, as well as allow users to write electronically in free-form fashion by touching an electronic pen to the computer display screen.

Many modern computer systems are hybrids between tablets allowing only pen input and traditional computers allowing only keyboard or mouse input. Such hybrid systems allow data input and manipulation via keyboards, mousing devices, and electronic pen devices. Unfortunately, such systems do not allow for a natural transition between one input mode and another. If the user desires to switch from a mouse mode to a pen mode, she must manually select the pen mode and, when she wishes to return to mouse mode, she must manually select mouse mode. Moreover, prior art systems do not allow for ready use of one input mode in the fashion of another input mode. For example, prior systems do not allow a user to readily use a pen in mouse mode and vice versa in a manner that seems natural to the user without undue manual selection by the user. Accordingly, there is a need for a method and system for improving the transition between input modes. It is with respect to these and other considerations that the present invention has been made.

### SUMMARY OF THE INVENTION

Embodiments of the present invention solve the above and other problems by providing for automatic detection and switching between computer-enabled input modes. Embodiments also provide for improved use of input modes by allowing input modes to more readily function as other input modes. For example, embodiments of the present invention allow for a pen to more readily function in a mouse mode and for a mousing device to more readily function in a pen mode.

According to aspects of the invention, an automatic switching input mode may be selected that allows input modes to be automatically switched from one mode to another based on user behavior. If a user's computer system is in selection mode (keyboard or mousing device), the user may enter and manipulate data via mouse movement or keyboard selection. If the user moves an electronic pen to the user's computer display screen, her computer system automatically switches to pen input mode without the requirement that the user manually switch to pen mode. Subsequently, if the user moves her mousing device or selects a key on her keyboard, her system automatically switches back to selection mode.

According to other aspects of the invention, one input mode may be readily latched for operation as a different input mode. For example, a user may latch a pen input mode for operation as a mouse input mode. Conversely, a mouse input mode may be latched for operation as a pen input mode. Each input mode may be easily switched back to its natural state based on user behavior.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a block diagram showing the architecture of a personal computer that provides an illustrative operating environment for embodiments of the present invention.

FIG. 2 is a simplified diagram illustrating a computer screen display adapted for use with an electronic pen and showing a computer keyboard and associated selection mode input devices.

FIG. 3 is a flow diagram showing an illustrative routine for automatically transitioning between computer-enabled input modes.

### DETAILED DESCRIPTION

As briefly described above, embodiments of the present invention are directed to methods and systems for automatically switching and transitioning between computer-enabled input modes. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

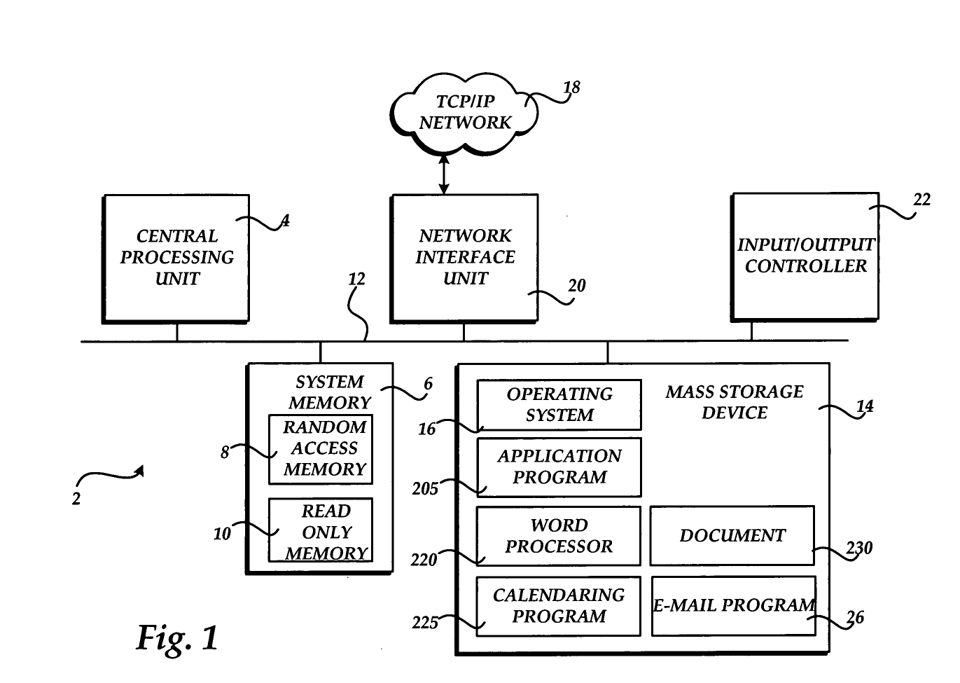

Referring now to the drawings, in which like numerals represent like elements through the several figures, aspects of the present invention and the exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Turning now to FIG. 1, an illustrative computer architecture for a personal computer 2 for practicing the various embodiments of the invention will be described. The computer architecture shown in FIG. 1 illustrates a conventional personal computer, including a central processing unit 4 (“CPU”), a system memory 6, including a random access memory 8 (“RAM”) and a read-only memory (“ROM”) 10, and a system bus 12 that couples the memory to the CPU 4. A basic input/output system containing the basic routines that help to transfer information between elements within the computer, such as during startup, is stored in the ROM 10. The personal computer 2 further includes a mass storage device 14 for storing an operating system 16, application programs, such as the application program 205, and data.

The mass storage device 14 is connected to the CPU 4 through a mass storage controller (not shown) connected to the bus 12. The mass storage device 14 and its associated computer-readable media, provide non-volatile storage for the personal computer 2. Although the description of computer-readable media contained herein refers to a mass storage device, such as a hard disk or CD-ROM drive, it should be appreciated by those skilled in the art that computer-readable media can be any available media that can be accessed by the personal computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the personal computer 2 may operate in a networked environment using logical connections to remote computers through a TCP/IP network 18, such as the Internet. The personal computer 2 may connect to the TCP/IP network 18 through a network interface unit 20 connected to the bus 12. It should be appreciated that the network interface unit 20 may also be utilized to connect to other types of networks and remote computer systems. The personal computer 2 may also include an input/output controller 22 for receiving and processing input from a number of devices, including a keyboard or mouse (not shown). Similarly, an input/output controller 22 may provide output to a display screen, a printer, or other type of output device.

As mentioned briefly above, a number of program modules and data files may be stored in the mass storage device 14 and RAM 8 of the personal computer 2, including an operating system 16 suitable for controlling the operation of a networked personal computer, such as the WINDOWS operating systems from MICROSOFT CORPORATION of Redmond, Wash. The mass storage device 14 and RAM 8 may also store one or more application programs. In particular, the mass storage device 14 and RAM 8 may store an application program 205 for creating and editing an electronic document 24. For instance, the application program 205 may comprise a word processing application program, a spreadsheet application, a contact application, and the like. Other applications illustrated in FIG. 1 and applicable to embodiments of the present invention include the word processing application 220, the calendar application 225 and the electronic mail application 26.

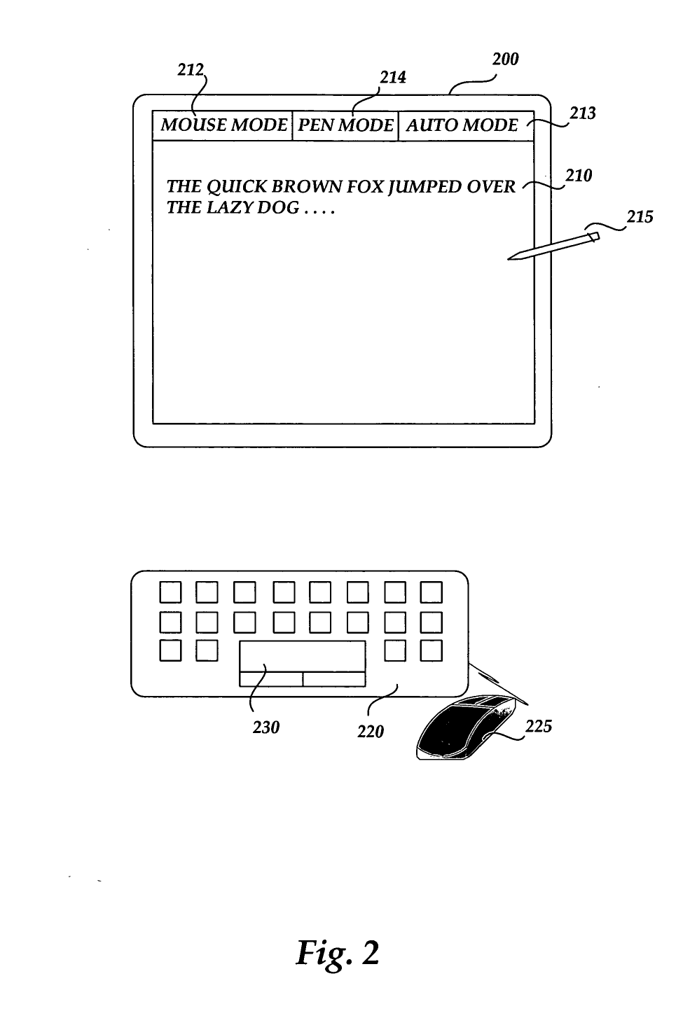

As briefly described above, embodiments of the present invention allow for automatic switching between computer-enabled input modes such as pen and ink input modes, mousing input modes, and keyboard input modes. Referring to FIG. 2, a computer screen display 200 is illustrative of a computer screen display for a conventional personal computer, a tablet type computer, a personal digital assistant, or any other electronic device that allows for the display of text or data and that allows for interaction between a user and the screen via an electronic pen 215. As shown in FIG. 2, an electronic pen 215 is illustrated touching the surface of the screen 200. A text selection 210 is illustrated on the screen 200 that may be input by free-form handwriting using the electronic pen 215 or by keystrokes from the keyboard 220, described below. As is known to those skilled in the art, pen and ink systems such as illustrated in FIG. 2 allow a user to utilize the electronic pen 215 to write in free-form text on the screen 200, allow the user to mark up text previously entered using a keyboard or an electronic pen and allow the user to select data displayed on the screen 200 for applying some type of functionality. Mechanisms for operation of electronic pen and ink systems with computer screen displays such as illustrated in FIG. 2 are well known to those skilled in the art.

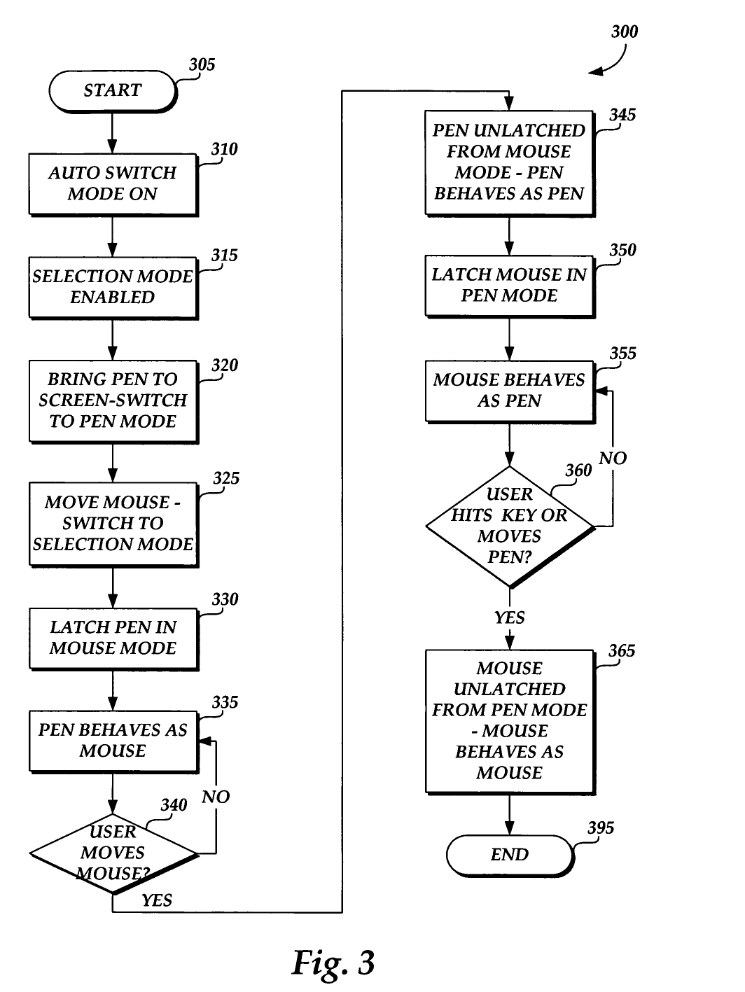

In accordance with embodiments of the present invention, the electronic pen 215 also may be selectively used to function in the fashion of a mousing device, such as the mouse 225, described below. That is, by placing the electronic pen 215 in a mouse mode, the electronic pen 215 takes on the characteristics of a mouse including movement of a cursor about the screen 200 and selection of a text or data insertion point at various places on the screen 200. Also shown for the screen 200 are a mouse mode button 212, an auto switch mode button 213 and a pen mode button 214. The mouse mode button 212 and the pen mode button 214 are illustrative of buttons for allowing a user to manually select between a selection mode (mousing device and keyboard mode) and a pen mode which allows input using the electronic pen 214. The auto switch mode button 213 button is illustrated for enabling automatic switching between input modes as will be described below with reference to FIG. 3. As will be described in detail below, embodiments of the present invention are directed to methods for allowing a more natural transition between a pen mode and a selection mode (mousing device and keyboard) without the requirement for manual selection between the two modes such as would be required by selecting the mouse mode button 212 or the pen mode button 214.

Referring still to FIG. 2, a keyboard 220 is illustrated having an associated mouse 225 and a touchpad 230. Mouse devices 225 and touchpads 230 are well known to those skilled in the art for allowing a user to move a cursor about the computer display screen 200, select insertion points for inserting text and data, select text or data for applying formatting or other functionality, and the like. It should be understood by those skilled in the art that the selection buttons and other displays illustrated in FIG. 2 are for purposes of illustration only and are not restrictive of the many types of computer screen displays, keyboards, input devices, function buttons, and the like that are available for use in accordance with embodiments of the present invention.

As will be described in detail below with reference to FIG. 3, embodiments of the present invention allow for a smooth transition between input modes such as the electronic pen 215, the mouse 225, and the touchpad 230. For example, an auto-switching input mode may be selected that allows a user to naturally and automatically switch from one input mode to the next. Additionally, embodiments of the present invention allow for latching one input mode so that it operates in the fashion of another input mode. For example, the electronic pen 215 may be latched so that it functions in mouse mode until it is unlatched by the user.

FIG. 3 is a flow diagram showing an illustrative routine for automatically transitioning between computer-enabled input modes. The routine 300 begins at start block 305 and proceeds to block 310, where the user selects the auto mode button 213 illustrated in FIG. 2. Selection of the auto input mode button 213 causes the operating system of the user's computer to automatically switch between input modes based on user behavior. At block 315, according to an embodiment of the present invention, a selection mode is enabled by default. The selection mode enabled by default places the user's system in a mouse device or keyboard selection mode in the first instance until that mode is changed by user behavior. At block 320, the user moves the electronic pen or stylus 215 to the display screen 200. At block 325, the user's system automatically switches from selection mode (mouse mode and keyboard mode) to pen mode. That is, without the requirement for the user to manually select pen mode by selecting the pen mode button 214, the user's system automatically switches to pen mode because the user's behavior of moving the electronic pen 215 to the screen 200 indicates that the user desires to use the pen 215 in pen mode for inputting data or otherwise manipulating data on the computer display screen 200. Advantageously, the user's experience is a more natural experience because the user develops the expectation that use of the pen automatically places the user in pen mode.

At block 325, the user stops using the electronic pen 215 and moves the mouse 225 or touches the touchpad 230. Moving of the mouse 225 or touching of the touchpad 230 causes the user's system to automatically switch from the pen mode back to the selection mode where input will now be received from the mouse 225, the touchpad 230, or the keyboard 220. According to one embodiment of the present invention, selection of a key on the keyboard 220 also automatically switches the input mode from the pen mode back to the selection mode. As with the case of automatic transition to the pen mode, the user receives a more natural user experience where use of the mouse 225, the touchpad 230, or the keyboard 220 automatically allows the user to input data, manipulate data, or otherwise use the functionality of those input modes without the need of manually switching to the selection mode such as selecting the mouse mode button 212.

As briefly described above according to embodiments of the present invention, a user may latch one input mode so that the input mode functions or behaves as another input mode. Continuing with the routine 300, at block 330, the user latches the pen 215 in mouse mode. According to one embodiment of the present invention, the user may latch the pen 215 in mouse mode by using the pen 215 to click or select the mouse mode button 212. As a result, at block 335, the pen 215 now functions or behaves in mouse mode. That is, much of the functionality normally associated with the mouse 225 or the touchpad 230 will now be performed by the pen 215. For example, the user may use the pen 215 to move a mouse cursor about the screen 200, the user may use the pen 215 to select an insertion point in the text 210, the user may use the pen 215 for selecting text in the text selection 210 for applying functionality, such as formatting, and the like.

According to embodiments of the present invention, the user may unlatch the pen from mouse mode by moving the mouse 225 or touching the touchpad 230. At block 340, a determination is made as to whether the user moves the mouse or touches the touchpad 230. If not, the routine moves back to block 335 and the pen 215 continues to operate in mouse mode until it is unlatched. If the user does move the mouse 225 or touch the touchpad 230, the routine moves to block 345, and the pen 215 is unlatched from mouse mode and begins to operate in pen mode once again. At any time that the pen or mouse are not latched for a particular type of functionality, the system reverts back to a default automatic mode switching operation, as described above with reference to blocks 310 and 315.

At block 350, the user latches the mouse 225 or touchpad 230 into pen mode. According to an embodiment of the present invention, the user may latch the mouse 225 or touchpad 230 into pen mode by using the mouse 225 or touchpad 230 to select the pen mode button 214. At block 355, the mouse 225 and touchpad 230 now behave in pen mode. That is, that functionality which is normally associated with the pen 215 is now exhibited by the mouse 225 and the touchpad 230. For example, use of the pen 215 to write free-form on the computer screen 200 may be performed with the mouse 225 or the touchpad 230. The user may unlatch the mouse or touchpad from pen mode by moving the pen 215 to the computer screen 200 or by pressing any key on the keyboard 220. Moving the pen 215, as described, or selecting a key on the keyboard automatically unlatches the mouse and touchpad 230 from pen mode. As described above, once the mouse or touchpad is unlatched from pen mode, the system automatically reverts back to auto-switching mode, as described above with reference to blocks 310 and 315.

At decision block 360, a determination is made as to whether the user does move the pen 215 or whether the user selects a key on the keyboard 220. If not, the routine proceeds back to block 355, and the mouse and touchpad continue to operate in pen mode. If the user does move the pen 215 or select a key on the keyboard 220, the routine moves to block 365 and the mouse and touchpad are unlatched from pen mode, and the mouse and touchpad once again operate in their natural state. The routine ends at block 395.

As described herein, methods and systems are provided for automatically transitioning between different computer-enabled input modes for allowing a user a more natural input mode experience. It will be apparent to those skilled in the art that various modifications or variations may be made in the present invention without departing from the scope or spirit of the invention. Other embodiments of the present invention will be apparent to those skilled in the art from consideration of the specification and practice of the invention disclosed herein.

1. A method of automatically switching between computer-enabled input modes, comprising:
enabling a selection-based input mode whereby input is accepted via a selection-based input device;
initiating use of a pen-based input device; and
in response to initiating use of a pen-based input device, automatically switching from the selection-based input mode to a pen-based input mode without user input.

2. The method of claim 1, further comprising initiating use of a selection-based input device; and
in response to initiating use of a selection-based input device, automatically switching from the pen-based input mode back to the selection-based input mode without user input.

3. The method of claim 2, prior to enabling a selection-based input mode, selecting an automatic input switching mode.

4. The method of claim 2, whereby the selection-based input device is a mousing device.

5. The method of claim 2, whereby the selection-based input device is a keyboard.

6. The method of claim 1, further comprising latching the selection-based input device so that the selection-based input device behaves as a pen-based input device.

7. The method of claim 6, whereby while the selection-based input device is latched for behavior as a pen-based input device, using the selection-based input device as a pen-based input device.

8. The method of claim 7, further comprising initiating use of the pen-based input device; and
in response to initiating use of the pen-based input device, automatically unlatching the selection-based input device from behaving as a pen-based input device.

9. The method of claim 8, whereby initiating use of the pen-based input device includes movement of the pen-based input device whereby said pen-based input device is operative to input data when the pen-based input device is engaged with a computer-enabled display screen operative to receive input from the pen-based input device.

10. The method of claim 1, further comprising latching the pen-based input device so that the pen-based input device behaves as a selection-based input device.

11. The method of claim 10, whereby while the pen-based input device is latched for behavior as a selection-based input device, using the pen-based input device as a selection-based input device.

12. The method of claim 11, further comprising initiating use of the selection-based input device; and
in response to initiating use of the selection-based input device, automatically unlatching the pen-based input device from behaving as a selection-based input device.

13. The method of claim 12, whereby initiating use of the selection-based input device includes moving a mousing device.

14. The method of claim 12, whereby initiating use of the selection-based input device includes selecting a keyboard key.

15. A method of automatically switching between computer-enabled input modes, comprising:
enabling a selection-based input mode whereby input is accepted via a selection-based input device;
initiating use of a computer-enabled electronic pen operative to input data when the electronic pen is engaged with a computer-enabled display screen operative to receive input from the electronic pen;
in response to initiating use of the computer-enabled electronic pen, automatically switching from the selection-based input mode to a pen-based input mode;
initiating use of a mousing device; and
in response to initiating use of the mousing device, automatically switching from the pen-based input mode to the selection-based input mode.

16. The method of claim 15, whereby the selection-based input device is a mousing device.

17. The method of claim 15, whereby the selection-based input device is a keyboard.

18. A method of automatically switching between computer-enabled input modes, comprising:
enabling a selection-based input mode whereby input is accepted via a selection-based input device;
initiating use of a pen-based input device;
in response to initiating use of a pen-based input device, automatically switching from the selection-based input mode to a pen-based input mode;
initiating use of a selection-based input device;
in response to initiating use of a selection-based input device, automatically switching from the pen-based input mode back to the selection-based input mode;
latching the selection-based input device so that the selection-based input device behaves as a pen-based input device;
initiating use of the pen-based input device, and in response to initiating use of the pen-based input device, automatically unlatching the selection-based input device from behaving as a pen-based input device;
latching the pen-based input device so that the pen-based input device behaves as a selection-based input device;
initiating use of the selection-based input device; and
in response to initiating use of the selection-based input device, automatically unlatching the pen-based input device from behaving as a selection-based input device.

19. The method of claim 18, whereby initiating use of the selection-based input device includes moving a mousing device.

20. The method of claim 18, whereby initiating use of the selection-based input device includes selecting a keyboard key.
